(19) United States
(12) Patent Application Publication
(10) Pub. No.: US 2021/0334117 A1
(43) Pub. Date: Oct. 28, 2021

(54) ELECTRONIC DEVICE

(71) Applicant: ASUSTeK COMPUTER INC., Taipei (TW)

(72) Inventors: Po-Chun Hsieh, Taipei (TW); Jen-Chieh Hung, Taipei (TW); Yu-Sheng Lin, Taipei (TW)

(21) Appl. No.: 17/301,673

(22) Filed: Apr. 12, 2021

(30) Foreign Application Priority Data
Apr. 22, 2020 (TW) 109204806

(51) Int. Cl. G06F 9/451; G06F 3/0482; G06F 3/0489; G06F 3/0488

(52) U.S. Cl. CPC G06F 9/451; G06F 3/04883; G06F 3/0489; G06F 3/0482

(57) ABSTRACT

An electronic device is adapted to be electrically connected with an input device and at least one display unit. The electronic device includes a processor configured to convert an input instruction from the input device to a corresponding a control instruction and transmit the control instruction to the display unit. The display unit displays the OSD menu or executes the adjustment function of the OSD menu according to the control instruction.

### CROSS-REFERENCE TO RELATED APPLICATION

This application claims the priority benefit of TW application serial No. 109204806, filed on Apr. 22, 2020. The entirety of the above-mentioned patent application is hereby incorporated by references herein and made a part of specification.

### BACKGROUND OF THE INVENTION

### Field of the Invention

The disclosure relates to an electronic device with a function of on-screen display (OSD).

### Description of the Related Art

Conventionally, when display settings of a monitor need to be adjusted, users can trigger physical buttons on the display frame to call and operate an OSD menu. Since physical buttons have different shapes, they are disposed at different positions, such as a back side, side edges, or bottom of electronic devices, and have different configurations. However, users are difficult to check the configuration positions of the physical buttons while operation. If a user triggers a wrong button, he or she needs to confirm how to exit and return to a target function. The efficiency is rather poor. Moreover, when the display is placed in a place far from the user, the user needs to walk near the display to perform display settings, which is rather inconvenient.

### BRIEF SUMMARY OF THE INVENTION

According to an aspect of the disclosure, an electronic device adapted to be electrically connected with an input device and at least one display unit is provided. The electronic device includes: a processor configured to convert an input instruction received from the input device to a control instruction, and transmit the control instruction to the at least one display unit, and the at least one display unit executes an on-screen display (OSD) menu function corresponding to the control instruction.

In summary, the OSD menu of the input device is called and operated via the input device of the electronic device in embodiments, which provide a more intuitive and quick operation ways. The intuitive operations are adapted to different models of the display devices to simplify the operation and increase user experiences. The OSD operation is more efficient, convenient, and overcomes the shortcomings of conventional display operation with physical buttons.

### BRIEF DESCRIPTION OF THE DRAWINGS

In order to make the above and other objectives, features, advantages and embodiments of the present disclosure more obvious and understandable, the description of the accompanying drawings is as follows:

FIG. 1 is a block diagram showing an electronic device, a connected input device and a display unit according to an embodiment.

FIG. 2 is a schematic diagram showing an electronic device, a connected input device and a display unit according to an embodiment.

FIG. 3 is a block diagram showing an electronic device, a connected input device and a display unit according to an embodiment.

FIG. 4 is a schematic diagram showing an electronic device, a connected input device and a display unit according to an embodiment.

FIG. 5 is a block diagram showing an electronic device connected to two display units according to an embodiment.

FIG. 6 is a schematic diagram showing an electronic device connected with two display units in an extern mode according to an embodiment.

FIG. 7 is a schematic diagram showing an electronic device connected with two display units in an extern mode according to an embodiment.

FIG. 8 is a schematic diagram showing an electronic device connected with two display units in a clone mode according to an embodiment.

### DETAILED DESCRIPTION OF THE EMBODIMENTS

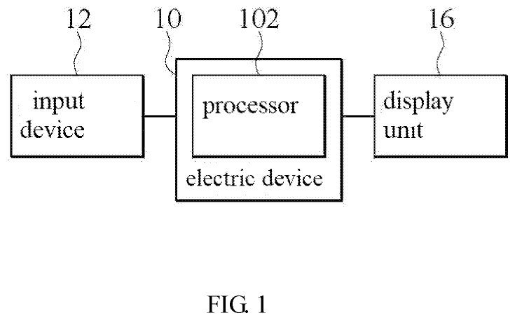

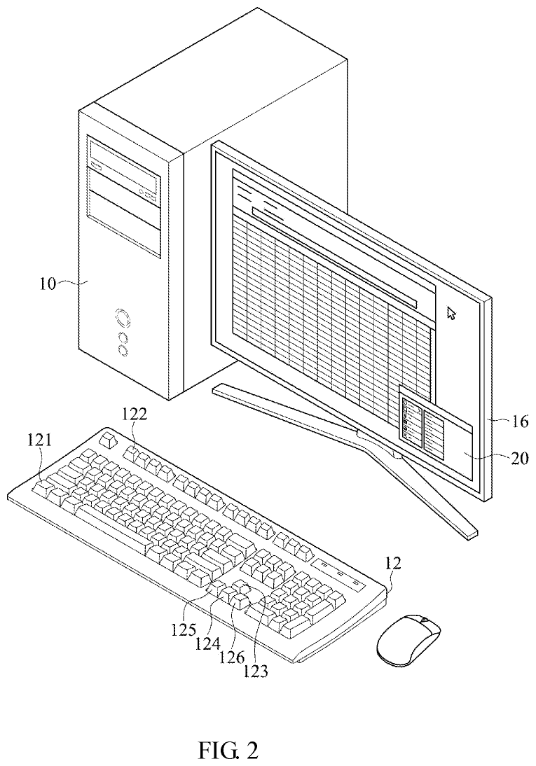

FIG. 1 is a block diagram showing an electronic device, connecting to an input device and a display unit according to an embodiment. FIG. 2 is a schematic diagram showing an electronic device, connected to an input device and a display unit according to an embodiment. Please refer to FIG. 1 and FIG. 2, an electronic device 10 is electrically connected to an input device 12 and a display unit 16. In an embodiment, the electronic device 10 is a system host or a notebook including a processor 102. The input device 12 is a keyboard. The keyboard generates an input instruction according to a shortcut key combination.

In an embodiment, the processor 102 of the electronic device 10 receives the input instruction from the input device 12, converts the input instruction to a control instruction, and transmits the control instruction to the display unit 16. The control instruction is a Display Data Channel Command Interface (DDC CI) instruction to facilitate the processor 102 of the electronic device 10 communicate with the display unit 16. The control instructions and functions are built in firmware of the display unit 16 in correspondence. When, a specific control instruction is transmitted from the processor 102, the display unit 16 executes the function of an OSD menu 20 according to the control instruction to set the display unit 16. In an embodiment, the input device 12 is electrically connected to the electronic device 10 wired or wirelessly, which is not limited herein.

In an embodiment, the input device 12 generates input instructions according to different shortcut key combinations, respectively. The input instruction is an activate instruction or an execution instruction. The activate instruction or the execution instruction is generated according to different shortcut key combinations. In an embodiment, when a shortcut key combination of the input device 12 is touched, the corresponding activate instruction is generated. The processor 102 receives the activate instruction, converts the activate instruction to the first control instruction of the control instruction, and transmits the first control instruction to the display unit 16 to control the display unit 16 to display the OSD menu 20 according to the first control instruction. At the time, the OSD menu 20 is displayed at the display unit 16. In an embodiment, another execution instruction is generated when another shortcut key combination of the input device 12 is touched, the processor 102 receives the another execution instruction, converts the another execution instruction to the second control instruction of the control instruction, and transmits the second control instruction to the display unit 16. The display unit 16 executes an adjustment function of the OSD menu 20 according to the second control instruction, that is, the OSD menu 20 displayed at the display unit 16 is selected and operated to further adjust the display unit 16.

In an embodiment, the shortcut key combination is set according to different requirements. For example, the shortcut key combination includes a Ctrl key 121 and a F1 function key 122 of the input device 12. When the Ctrl key 121 and the F1 function key 122 are touched simultaneously, the input device 12 generates the activate instruction. The activate instruction is transmitted to the processor 102 of the electronic device 10. The processor 102 converts the activate instruction to the first control instruction. Then, the display unit 16 displays the OSD menu 20 according to the first control instruction. In an embodiment, another shortcut key combination includes the Ctrl key 121 and a direction key of the input device 12. The direction key is an Up arrow key 123, a down arrow key 124, a left arrow key 125, or a right arrow key 126. When the OSD menu 20 is brought up and the Ctrl key 121 and one of the Up arrow key 123, the down arrow key 124, the left arrow key 125, or the right arrow key 126 are touched, the input device 12 generates the corresponding execution instruction to the processor 102. The processor 102 converts the execution instruction to the second control instruction and transmits the execution instruction to the display unit 16. Then, the display unit 16 executes the corresponding adjustment function of the OSD menu 20 according to the second control instruction, such as the up, down, enter, quit functions at the OSD menu 20, which is convenient for users. In an embodiment, the shortcut key combination includes one of the Ctrl key 121, the Shift key (not shown) or the Alt key (not shown) and one of a numeric key, a letter key, or a symbolic key. When the OSD menu 20 is brought up, and a direction key and one of the Ctrl key 121, the Shift key(not shown), or the Alt key (not shown) are touched, the up, down, enter or quit function of the OSD menu 20 is executed, which is not limited herein. The operations are much convenient for users.

In an embodiment, the electronic device 10 is used as a communication intermediary between the input device 12 and the display unit 16. To convert the input instruction from the input device 12 to the control instruction for the display unit 16, a software tool is installed in the processor 102 of the electronic device 10. When the original input device 12 cooperates with the display unit 16 supporting the control instruction, the OSD menu 20 of the target display unit 16 is operated.

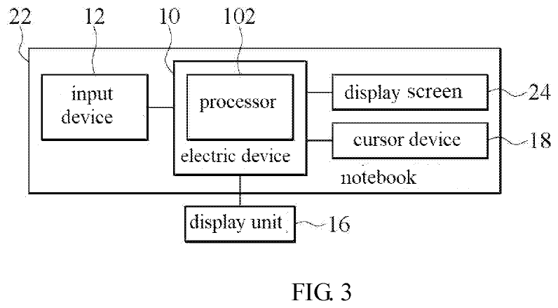

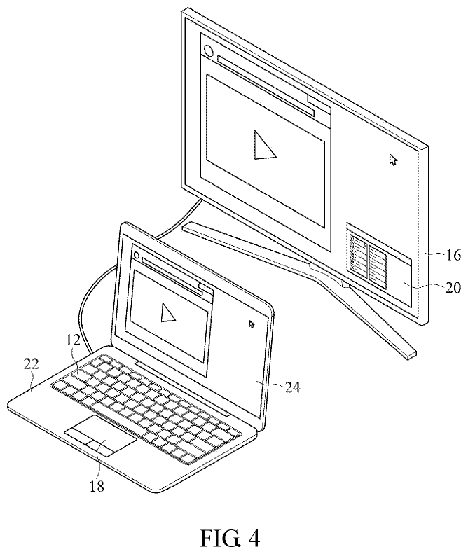

In an embodiment, the electronic device 10, the input device 12, and a cursor device 18 are embodied as a notebook computer 22. Please refer to FIG. 3 and FIG. 4, the notebook computer 22 includes the electronic device 10, the input device 12 and the cursor device 18. The notebook computer 22 equips with the functions of the electronic device 10, the input device 12 and the cursor device 18. Besides an original display screen 24 of the notebook computer 22, the notebook computer 22 (the electronic device 10) is further connected to an external display unit 16. Then, the input device 12 of the notebook computer 22 controls the display unit 16 to display the OSD menu 20 and execute the adjustment function via operating the OSD menu 20. The operations are similar to above embodiment, which are not described herein for a concise purpose.

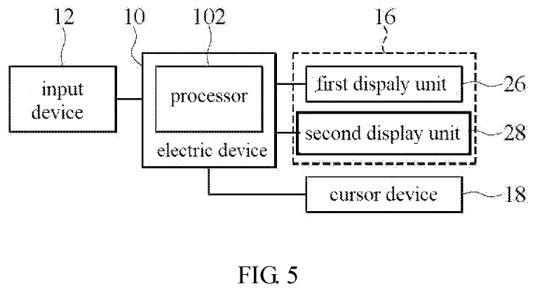

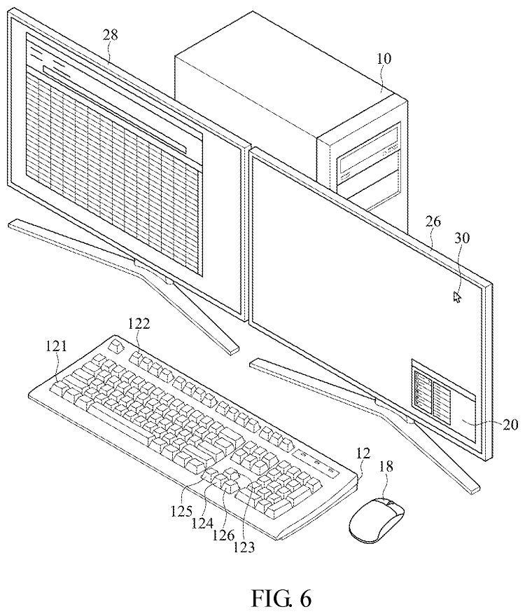

In an embodiment, the electronic device 10 is electrically connected to a plurality of display units 16. In the embodiment, the number of the display unit 16 is two. Please refer to FIG. 5 and FIG. 6, the electronic device 10 is electrically connected to the input device 12, a first display unit 26, a second display unit 28, and the cursor device 18. In an embodiment, the electronic device 10 is a system host including the processor 102. In an embodiment, the input device 12 is a keyboard. The keyboard generates the input instruction according to the shortcut key combination. The processor 102 of the electronic device 10 receives the input instruction from the input device 12, converts the input instruction to a corresponding control instruction, and transmits the control instruction to the first display unit 26 or the second display unit 28. The first display unit 26 or the second display unit 28 executes the activate function or the adjustment function of the OSD menu 20 according to the control instruction. The cursor device 18 controls a cursor 30. The cursor device 18 is a mouse or a touch pad. The cursor device 18 is electrically connected to the electronic device 10 in a wired or wireless connection, which is not limited herein.

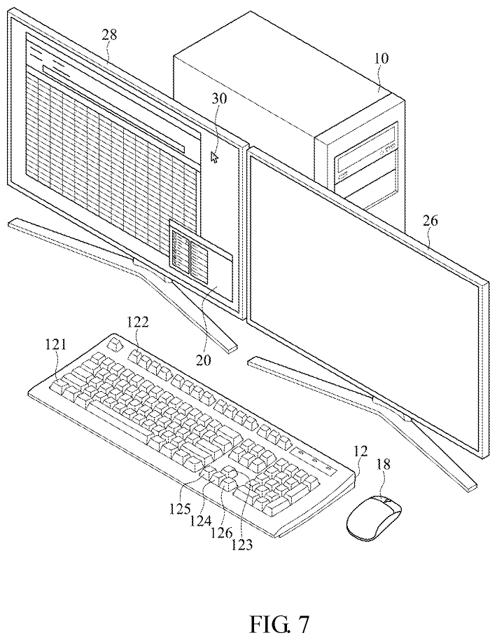

One of the first display unit 26 and the second display unit 28 is selected according to the collocation of the electronic device 10 and the cursor device 18. In an embodiment, when the screen of the first display unit 26 and the second display unit 28 is in an extern mode, the cursor device 18 controls the cursor 30 to move to the first display unit 26. At the time, the Ctrl key 121 and the F1 function key 122 are used as the shortcut key combination and touched simultaneously, the input device 12 generates the activate instruction and transmits the activate instruction to the processor 102 of the electronic device 10. The processor 102 converts the activate instruction to the first control instruction and transmits the first control instruction to the first display unit 26. The first display unit 26 displays the OSD menu 20 according to the first control instruction. When the OSD menu 20 is displayed, the Ctrl key 121 and one of the right arrow key 126 the Up arrow key 123, the down arrow key 124 and the left arrow key 125 are touched, the input device 12 generates the corresponding execution instruction to the processor 102 of the electronic device 10. The execution instruction is converted to the second control instruction via the processor 102, the adjustment function of the OSD menu 20 is executed via the first display unit 26 according to the second control instruction. When the second display unit 28 needs to be adjusted, the cursor 30 is moved to the second display unit 28 via the cursor device 18. As shown in FIG. 7. Similarly, the second display unit 28 with the cursor 30 displays the OSD menu 20 or executes the adjustment function of the OSD menu 20 according to the control instruction. The second display unit 28 displays the OSD menu 20 and executes the adjustment function. As a result, when the first display unit 26 and the second display unit 28 are in the extern mode, the OSD menu 20 of the first display unit 26 of the electronic device 10 is enabled by the cursor 30 shown in the corresponding display unit 26, and the OSD menu 20 of the second display unit 28 also is enabled by moving the cursor 30 form the first display unit 26 to the second display unit 28 via the cursor device 18, which is very convenient.

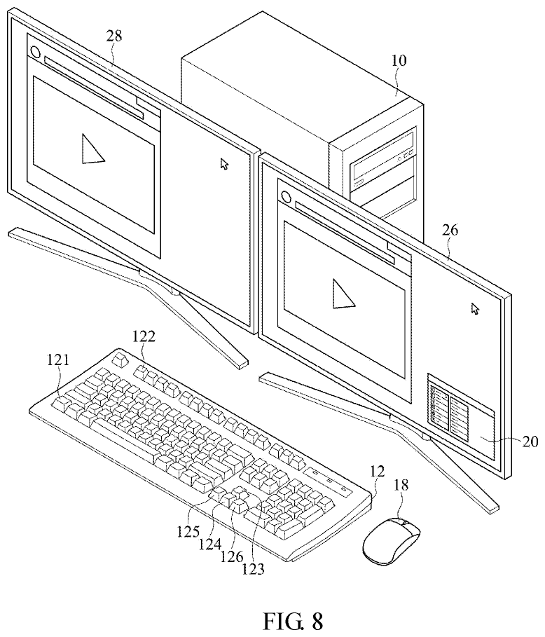

Please refer to FIG. 5 and FIG. 8, when the first display unit 26 and the second display unit 28 are in a clone mode, in order to bring up the OSD menus 20 of the first display unit 26 and the second display unit 28, the processor 102 generates the control signal to the first display unit 26 and the second display unit 28 in sequence when the shortcut key combination (including the Ctrl key 121 and the F1 function key 122) is touched. The first display unit 26 and the second display unit 28 in the clone mode are switched in sequence, and the OSD menu 20 is displayed in turn by the first display unit 26 and the second display unit 28. When the OSD menu 20 is displayed at the first display unit 26, the adjustment function of the OSD menu 20 is executed by touching the Ctrl key 121 and one of the Up arrow key 123, the down arrow key 124, the left arrow key 125, or the right arrow key 126. If the first display unit 26 does not need to be adjusted when the OSD menu 20 is displayed at the first display unit 26, the shortcut key combination including the Ctrl key 121 and the F1 function key 122 is touched to switch the OSD menu 20 to the second display unit 28, to adjust the second display unit 28.

Conventionally, the positon of keys cannot be seen very clearly, and thus the keys are usually mis-pressed by users. In this disclosure, the direction keys of an input device are utilized instead of physical buttons, and thus the operations are more intuitive. Furthermore, the operation is adapted to various display units. Operation instructions of the input device are quickly responded, and the efficiency is higher than that of physical button operations. When the display units are in the extern mode, the target display unit is operated more intuitive via the control of the cursor of the cursor device. When the display units are in the clone mode, the OSD menu of the display units are brought out and operated separately.

In summary, the OSD menu of the input device is brought out and operated via the input device of the electronic device in this disclosure, which provide a more intuitive and faster operation ways. The same operations are adapted to the display devices of different models. The OSD operation is more efficient, convenient, and overcome the shortcomings of conventional display adjustments with physical buttons.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. An electronic device, adapted to be electrically connected with an input device and at least one display unit, the electronic device including:
a processor configured to convert an input instruction received from the input device to a control instruction, and transmit the control instruction to the at least one display unit, and the at least one display unit executes an on-screen display (OSD) menu function corresponding to the control instruction.

2. The electronic device according to claim 1, wherein the input instruction is generated according to a shortcut key combination of the input device.

3. The electronic device according to claim 2, wherein the input instruction further includes an activate instruction and an execution instruction, the activate instruction and the execution instruction are generated according to different shortcut key combinations.

4. The electronic device according to claim 3, wherein the processor receives the activate instruction and converts the activate instruction to the control instruction, the at least one display unit displays the OSD menu according to the control instruction.

5. The electronic device according to claim 3, wherein the processor receives the execution instruction and converts the execution instruction to the control instruction, and the at least one display unit executes the adjustment function of the OSD menu according to the control instruction.

6. The electronic device according to claim 1, wherein the electronic device is electrically connected to a cursor device to control a cursor.

7. The electronic device according to claim 6, wherein the number of the at least one display unit is plurality, and when the display units are in an extern mode, the cursor device controls the cursor to be at one of the display units, the display unit with the cursor executes the OSD menu function according to the control instruction.

8. The electronic device according to claim 6, wherein the cursor device is a mouse or a touchpad.

9. The electronic device according to claim 2, wherein the number of the at least one display unit is plurality, and when the display units are in the clone mode, the processor generates the control signal in sequence to the display units when on the shortcut key combination is touched continuously, to control the display units to display the OSD menu in sequence.

10. The electronic device according to claim 1, wherein the control instruction is a Display Data Channel Command Interface (DDC CI) instruction.

11. The electronic device according to claim 2, wherein the input instruction is generated according to the shortcut key combination which is a combination of a direction key and one of Alt key and a Ctrl key, or a Shift key.
